(19) United States
(12) Patent Application Publication
(10) Pub. No.: US 2026/0177709 A1
(43) Pub. Date: Jun. 25, 2026

(54) GAIN COMPENSATION METHOD AND MODULE AND TARGET VOLTAGE DETERMINATION METHOD

(71) Applicant: Shanghai United Imaging Healthcare Co., Ltd., Shanghai (CN)

(72) Inventors: Xu Chen, Shanghai (CN); Dongdong Bi, Shanghai (CN); Pengyu Ke, Shanghai (CN); Zhiyong Song, Shanghai (CN); Lei Xiao, Shanghai (CN); Ziwei Li, Shanghai (CN); Sihang Yang, Shanghai (CN); Shaoping Chu, Shanghai (CN)

(21) Appl. No.: 19/428,364

(22) Filed: Dec. 22, 2025

(30) Foreign Application Priority Data
Dec. 20, 2024 (CN) 202411898717.2
Dec. 20, 2024 (CN) 202411900674.7

(51) Int. Cl. G01T 1/164; G01D 5/14; G01T 1/161

(52) U.S. Cl. CPC G01T 1/1645; G01T 1/1615; G01D 5/142

(57) ABSTRACT

The present application relates to a gain compensation method and module and a target voltage determination method. The gain compensation method includes: acquiring angle data of the photomultiplier tube of the detector; the angle data being used for representing a relative angle between the photomultiplier tube and an environmental magnetic field; and outputting a voltage compensation signal to an adjustable power supply circuit according to the angle data; the voltage compensation signal is used for instructing the adjustable power supply circuit to adjust a supply voltage output to each photomultiplier tube, so as to cause an output amplitude of the photomultiplier tube to reach an expected output amplitude.

### RELATED APPLICATION

This application claims the benefit under 35 U.S.C. § 119 (a) of the filing date of Chinese Patent Application No. 202411900674.7, filed in the Chinese Patent Office on Dec. 20, 2024, and of Chinese Patent Application No. 202411898717.2, filed in the Chinese Patent Office on Dec. 20, 2024. The disclosures of the foregoing applications are herein incorporated by reference in its entirety.

### TECHNICAL FIELD

The present application relates to the field of medical technologies, and in particular, to a gain compensation method and module and a target voltage determination method.

### BACKGROUND

Emission Computed Tomography (ECT) includes single photon emission computed tomography (SPECT) systems, positron emission tomography (PET), or the like. The ECT includes a detector, and the detector includes a photoelectric detection element as a core detection element. In the SPECT system, the detector includes a photomultiplier tube (PMT) as the core detection element, and in the PET, the detector includes a silicon photomultiplier (SiPM) as the core detection element, which is responsible for converting a received nuclear radiation signal into a measurable photocurrent.

However, in practical applications, especially when a SPECT probe performs multi-pose detection, the PMT inevitably cuts a magnetic field of the earth during rotation, resulting in a shift of a transmission path of the photocurrent between dynodes. The shift is particularly significant when the PMT is perpendicular to the magnetic field of the earth, so that even for same nuclear signal input, output signals of the PMT are inconsistent, that is, a current gain becomes instable due to an influence of the magnetic field of the earth. Especially under the condition of a high counting rate, the nonlinearity and the gain change are more prominent, which seriously affects quality of SPECT images and accuracy of diagnosis.

On the other hand, a supply voltage of the SiPM of the detector of the PET system is quite important. The supply voltage can affect energy, a signal amplitude, application specific integrated circuit (ASIC) scan noise, a final time of flight (TOF) result, or the like, of a PET system. Therefore, selection of the supply voltage is quite important.

### SUMMARY

The present application provides a supply voltage gain compensation method and module for a photoelectric detection element of a detector, a computer-readable storage medium, an SPECT system, a target voltage determination method for a photoelectric detection element of a detector, a computer device, and a supply voltage adjusting circuit for a photoelectric detection element of a detector.

In a first aspect, the present application provides a supply voltage gain compensation method for a photoelectric detection element of a detector; the detector is a detector of a SPECT system, the photoelectric detection element is a photomultiplier tube, and the method includes: acquiring angle data of the photomultiplier tube of the detector; the angle data being used for representing a relative angle between the photomultiplier tube and an environmental magnetic field; and outputting a voltage compensation signal to an adjustable power supply circuit according to the angle data; The voltage compensation signal is used for instructing the adjustable power supply circuit to adjust a supply voltage output to each photomultiplier tube, so as to cause an output amplitude of the photomultiplier tube to reach an expected output amplitude.

In an embodiment, outputting the voltage compensation signal to the adjustable power supply circuit according to the angle data includes: determining a compensation coefficient corresponding to the angle data according to the angle data and prestored gain compensation matrix data; and outputting the voltage compensation signal to the adjustable power supply circuit according to the compensation coefficient; The gain compensation matrix data is used for representing a mapping relationship between the angle data and the compensation coefficient.

In an embodiment, the method further includes: generating and sending a warn signal under a condition that an operating time of the detector is greater than a preset time.

In an embodiment, the method further includes: acquiring data of the environmental magnetic field; and generating and sending a warn signal under the condition that a change amplitude of the data of the environmental magnetic field exceeds a preset amplitude is greater than a preset time.

In an embodiment, a step of determining the voltage compensation signal includes: determining the voltage compensation signal according to the compensation coefficient, a target output gain and the following gain relation: code=10\hat{ }(a*HV−b); Code is the target output gain, a and b are the compensation coefficients, and HV is the voltage compensation signal.

In an embodiment, the method further includes: rotating the detector under a condition that the warn signal is generated and sent; recording the angle data and the output amplitude of the photomultiplier tube in the rotation process; and in the case where the output amplitude of the photomultiplier tube does not reach the expected output amplitude under at least one piece of angle data, updating the prestored gain compensation matrix data.

In a second aspect, the present application further provides a gain compensation module (i.e., assembly) applied to a detector of a SPECT system, the gain compensation module including: an angle sensor configured to collect angle data of a photomultiplier tube of the detector; the angle data being used for representing a relative angle between the photomultiplier tube and an environmental magnetic field; an adjustable power supply circuit configured to provide a supply voltage for each photomultiplier tube; and a controller connected to the angle sensor and the adjustable power supply circuit respectively, the controller being configured to perform the steps of the method according to the above-described embodiment.

In an embodiment, the controller is configured to generate and send a warn signal under a condition that an operating time of the detector is greater than a preset time; or the compensation module further includes a Hall sensor configured to collect data of the environmental magnetic field; and the controller is connected to the Hall sensor, and the controller is configured to acquire data of the environmental magnetic field and generate and send a warn signal under a condition that a change amplitude of the data of the environmental magnetic field exceeds a preset amplitude.

In an embodiment, the angle sensor is a gyroscope, and the gyroscope has a consistent pose with the photomultiplier tube.

In a third aspect, the present application further provides a computer-readable storage medium having a computer program stored thereon, the computer program, when executed by a processor, implementing the steps of the above supply voltage gain compensation method for a photoelectric detection element of a detector according to the first aspect.

In a fourth aspect, the present application further provides a SPECT system including: a detector; and the gain compensation module according to the above embodiment.

In a fifth aspect, the present application provides a target voltage determination method for a photoelectric detection element of a detector, including: acquiring detector performance parameters corresponding to a plurality of alternative voltages; inputting the detector performance parameters into a preset evaluation model to obtain an evaluation result corresponding to each alternative voltage; the evaluation model being a model representing different weights occupied by detector performance parameters in different dimensions in a process of predicting evaluation results; and selecting the alternative voltage with the optimal evaluation result as a target voltage.

In an embodiment, the detector performance parameters include at least a time of flight, an energy resolution and sensitivity, and a training process of the preset evaluation model includes: acquiring a first training sample set, the first training sample set including detector performance parameters corresponding to a plurality of voltage values and corresponding actual evaluation results; inputting the detector performance parameters corresponding to the voltage values in the first training sample set into a first preset learning model to obtain predicted evaluation results; adjusting weights of the detector performance parameters in the first preset learning model based on deviations between the predicted evaluation results and the actual evaluation results corresponding to the voltage values until a first ending condition is met; and taking the trained first preset learning model as the evaluation model.

In an embodiment, a weight of the time of flight is greater than a weight of the energy resolution, and the weight of the energy resolution is greater than a weight of the sensitivity.

In an embodiment, acquiring the detector performance parameters corresponding to the plurality of alternative voltages includes: respectively inputting the multiple alternative voltages into a preset detector performance parameter prediction model to obtain the detector performance parameter corresponding to each alternative voltage.

In an embodiment, a training process of the detector performance parameter prediction model includes: acquiring a second training sample set, the second training sample set including a plurality of voltage values and detector actual performance parameters corresponding to the voltage values; inputting the voltage values in the second training sample set into a second preset learning model to obtain detector predicted performance parameters corresponding to the voltage values; adjusting model parameters of the second preset learning model based on deviations between the detector predicted performance parameters and the detector actual performance parameters until a second ending condition is met; and taking the trained second preset learning model as the detector performance parameter prediction model.

In an embodiment, a step of acquiring the plurality of alternative voltages includes: determining an initial voltage; and determining the plurality of alternative voltages according to a preset voltage step by taking the initial voltage as a reference.

In an embodiment, the different weights occupied by the detector performance parameters in different dimensions in the process of predicting the evaluation results are determined based on machine learning training.

In an embodiment, the first preset model includes a normalization model and a weight-based scoring model, the normalization model is configured to normalize detector performance parameters in multiple dimensions, and then input the normalized results into the weight-based scoring model, and the scoring model is: Y=Σ(Ki*Xi); Y is the evaluation result, Ki is the weight of the detector performance parameter in an ith dimension, and Xi is the normalized result of the detector performance parameter in the ith dimension.

In an embodiment, the first ending condition means that a preset maximum iterative training time number is reached, or the deviation between the predicted evaluation result and the actual evaluation result corresponding to the voltage value is within a preset deviation range, or training samples in the first sample training set are traversed.

In an embodiment, the weight of the time of flight is greater than the weight of the energy resolution, and the weight of the energy resolution is greater than or equal to the weight of the sensitivity.

In an embodiment, the second ending condition means that a preset maximum iterative training time number is reached, or the deviation between the detector predicted performance parameter and the detector actual performance parameter is within a preset deviation range, or samples in the second training sample set are traversed.

In a sixth aspect, the present application provides a computer device, including a memory and a processor, the memory storing a computer program, and the processor implementing the steps of the target voltage determination method for a photoelectric detection element of a detector according to the fifth aspect when executing the computer program.

In a seventh aspect, the present application provides a supply voltage adjusting circuit for a photoelectric detection element of a detector, including: a voltage collecting circuit, an input end of the voltage collecting circuit being configured to be connected to an output end of a power supply circuit, so as to collect an actual output voltage of the power supply circuit; and a control circuit, an input end of the control circuit being connected to an output end of the voltage collecting circuit, an output end of the control circuit being configured to be connected to a controlled end of the power supply circuit, and the control circuit being configured to adjust the power supply circuit according to a target voltage and the actual output voltage, so as to cause the actual output voltage to be stabilized at the target voltage; the target voltage is determined by performing the steps of the target voltage determination method for a photoelectric detection element of a detector according to the fifth aspect.

In an embodiment, the voltage collecting circuit includes: an attenuator, an input end of the attenuator being configured to be connected to the output end of the power supply circuit, and the attenuator being configured to attenuate the output voltage of the power supply circuit and output the attenuated output voltage; and an analog-to-digital sampling circuit, an input end of the analog-to-digital sampling circuit being connected to the input end of the attenuator, the analog-to-digital sampling circuit being configured to perform analog-to-digital conversion on an input signal and then amplify the result by a preset factor, and the preset factor being the same as an attenuation factor of the attenuator.

In an embodiment, the control circuit includes: a comparator, an input end of the comparator being connected to the output end of the voltage collecting circuit, and a reference end of the comparator being configured to receive a reference signal corresponding to the target voltage; and a feedback adjusting network, an input end of the feedback adjusting network being connected to an output end of the comparator, an output end of the feedback adjusting network being configured to be connected to the power supply circuit, and the feedback adjusting network being configured to adjust an equivalent resistance of the power supply circuit, so as to cause the actual output voltage of the power supply circuit to be stabilized at the target voltage.

### BRIEF DESCRIPTION OF THE DRAWINGS

In order to illustrate the technical solutions in the embodiments of the present application or the prior art more clearly, the drawings required for describing the embodiments or the prior art will be described briefly. Apparently, the following described drawings are merely for some embodiments of the present application, and other drawings can be derived from these drawings by those of ordinary skill in the art without any creative effort.

FIG. 1 is a schematic structural diagram of a photomultiplier tube in the prior art;

FIG. 2 is a graph of relative output of the photomultiplier tube under influences of a magnetic field;

FIG. 3 is a schematic flow diagram of a supply voltage gain compensation method for a photoelectric detection element of a detector according to an embodiment;

FIG. 4 is a schematic flow diagram of the supply voltage gain compensation method for a photoelectric detection element of a detector according to another embodiment;

FIG. 5 is a schematic diagram of a scenario of rotation with a photocathode of a photomultiplier tube in a fixed direction in an embodiment;

FIG. 6 is a schematic diagram of a scenario of rotation with the photocathode in a changed direction in another embodiment;

FIG. 7 is a change graph of relative output of the photomultiplier tube at different rotation angles measured under the scenario of FIG. 5;

FIG. 8 is a change graph of relative output of the photomultiplier tube at different rotation angles measured under the scenario of FIG. 6;

FIG. 9 is a schematic structural diagram of a supply voltage gain compensation module according to an embodiment;

FIG. 10 is a schematic structural diagram of the supply voltage gain compensation module according to another embodiment;

FIG. 11 is a schematic structural diagram of the supply voltage gain compensation module according to still another embodiment;

FIG. 12 is a structural block diagram of a supply voltage gain compensation apparatus according to an embodiment;

FIG. 13 is a first schematic flow diagram of a target voltage determination method for a photoelectric detection element of a detector according to one or more embodiments;

FIG. 14 is a schematic flow diagram of a training step of a preset evaluation model in one or more embodiments;

FIG. 15 is a second schematic flow diagram of the target voltage determination method for a photoelectric detection element of a detector according to one or more embodiments;

FIG. 16 is a schematic flow diagram of a training step of a detector performance parameter prediction model in one or more embodiments;

FIG. 17 is a schematic flow diagram of a step of determining a plurality of alternative voltages in one or more embodiments;

FIG. 18 is a structural block diagram of a target voltage determination apparatus of a photoelectric detection element of a detector according to one or more embodiments;

FIG. 19 is a first schematic circuit structure diagram of a supply voltage adjusting circuit for a detector according to one or more embodiments;

FIG. 20 is a second schematic circuit structure diagram of the supply voltage adjusting circuit for a detector according to one or more embodiments; and

FIG. 21 is an internal structure diagram of a computer device according to an embodiment.

### DETAILED DESCRIPTION

To facilitate an understanding of the present application, the present application is described more fully hereinafter with reference to the accompanying drawings. Embodiments of the present application are shown in the drawings. However, the present application may be implemented in many different forms and is not limited to the embodiments set forth herein. Rather, these embodiments are provided to make the disclosure of the present application more thorough and complete.

Unless defined otherwise, all technical and scientific terms used herein have the same meanings as are commonly understood by those skilled in the art. The terms used herein in the specification of the present application are for the purpose of describing specific embodiments only but not intended to limit the present application.

It should be noted that when an element is considered to be “connected to” another element, the element may be connected to the other element directly or through an intermediate element. In addition, “connection” in the following embodiments is understood to be “electrical connection”, “communication connection”, or the like, if there is transfer of electrical signals or data between connected objects.

As used herein, the singular forms “a”, “an”, and “the” may include the plural forms as well, unless the context clearly indicates otherwise. It should be further understood that the terms “includes/comprises”, “has”, or the like, specify the presence of stated features, integers, steps, operations, assemblies, parts, or combinations thereof, but do not preclude the presence or addition of one or more other features, integers, steps, operations, assemblies, parts, or combinations thereof.

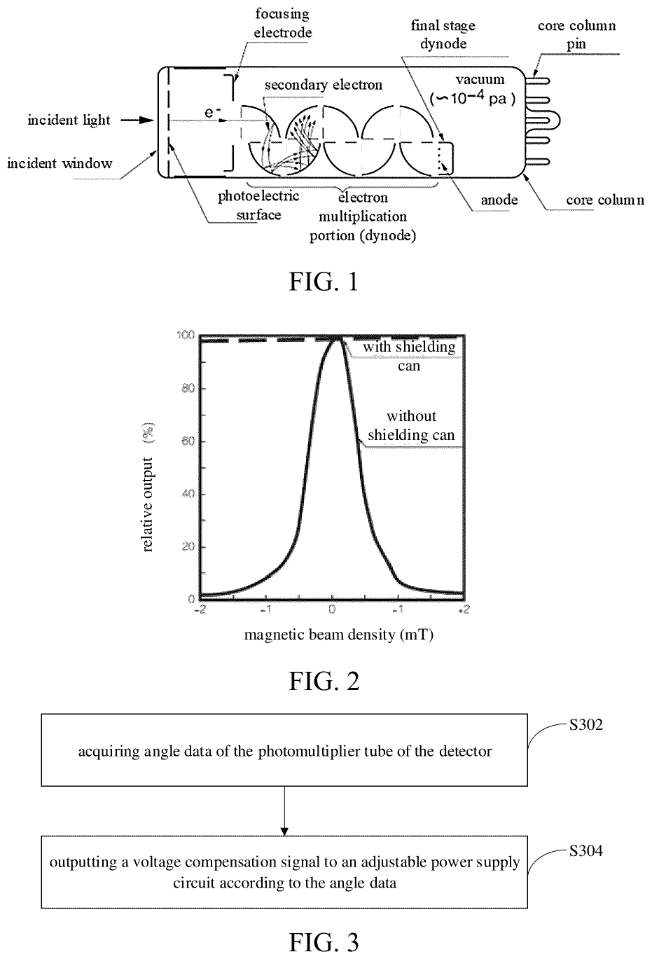

A plurality of photomultiplier tubes (PMTs) shown in FIG. 1 are usually used in a detector in a SPECT system, and an electron multiplication direction of the photomultiplier tube is from a photocathode to an anode. In order to closely arrange the PMTs, the PMTs are usually staggered and dead zones therebetween are minimized. For the closely arranged PMTs, the following two solutions for shielding the PMTs in the detector from a magnetic field of the earth are known currently. One is a magnetic shielding can solution: a magnetic shielding can is made of a high permeability material (e.g., permalloy), the PMTs are placed in the middle of the barrel, and a magnetic shielding effect is related to a thickness and diameter of the shielding can in addition to the material. As shown in FIG. 2, relative output of the photomultiplier tube changes under an influence of an external magnetic field (e.g., magnetic beam density), and the magnetic field influences an electron transition process in this process, so that electrons are incompletely collected, and the influence can be effectively solved by adding the magnetic shielding can. This solution is a mainstream technical means at present, and has a good shielding effect, a simple technical route and a moderate manufacturing cost, main technical difficulty lies in roundness and a production tolerance of the shielding can, different manufacturers have inconsistent technological levels, and mechanical assembly conflicts can be caused by a large tolerance. Meanwhile, in order to be compatible with the production tolerance, a larger assembly space needs to be reserved in the detector, redundancy of a probe, a weight and the dead zones between the PMTs are increased, and certain risks are brought to whole quality and performances. The other is a magnetic shielding film solution: a plurality of permalloy films are wrapped on surfaces of the PMTs, the solution has a certain effect on an unshielded product, brings bigger redundancy for the assembly space, and realizes smaller dead zones between the PMTs, but since the surfaces of the PMTs are not regular cylinders, technologies currently known at home and abroad for winding the shielding films are mostly manually performed, bending angles are obvious, surface tolerances are difficult to control, and an integrally forming technology is difficult to implement; the shielding films have a small thickness, so that a shielding effect cannot reach a same level as the shielding can.

For the above reasons, in an exemplary embodiment, as shown in FIG. 3, the present application provides a supply voltage gain compensation method for a photoelectric detection element of a detector, and in this embodiment, the detector is, for example, a detector in a SPECT system, and the photoelectric detection element is, for example, a photomultiplier tube. The method includes:

S302: acquiring angle data of the photomultiplier tube of the detector; the angle data being used for representing a relative angle between the photomultiplier tube and an environmental magnetic field. The angle data may be a rotation angle of the photomultiplier tube around a rotation axis, an included angle between an electron multiplication direction of the photomultiplier tube and a direction of a magnetic field of the earth, or the like. That is, the angle data may be any angle data capable of representing a change of a relative angle between the photomultiplier tube and the environmental magnetic field.

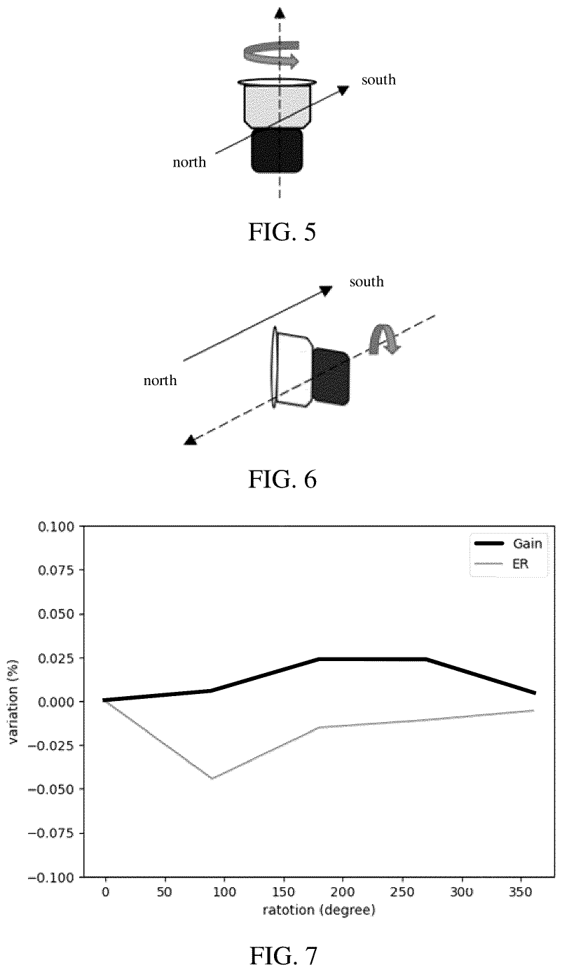

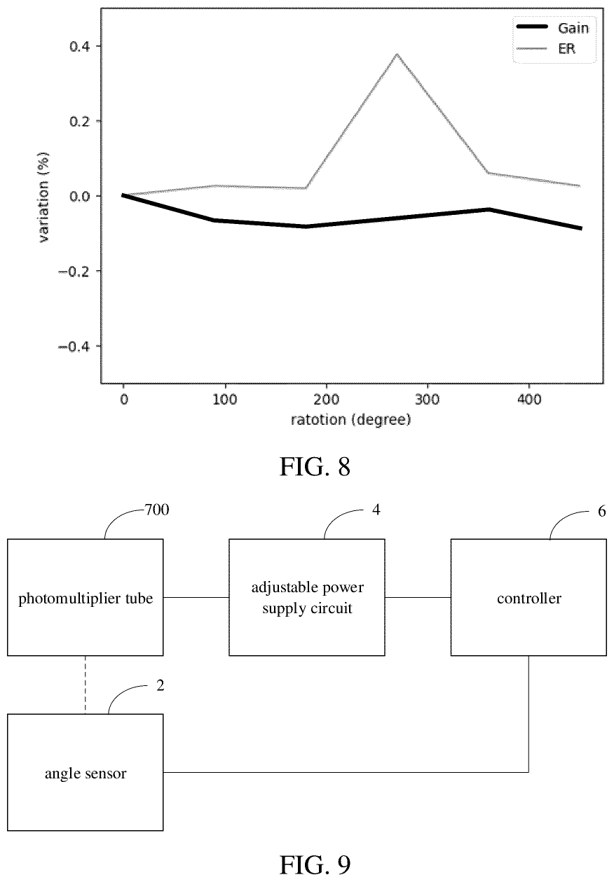

The environmental magnetic field refers to a magnetic field around the detector, and mainly includes a magnetic field naturally generated by the earth. In the SPECT system, when the PMT is arranged within the detector of the SPECT system, and the PMT moves or rotates with the detector, the relative position of the PMT and the environmental magnetic field changes, which affects a transmission path of a photocurrent within the PMT, and in turn affects an output signal of the PMT. Taking the environmental magnetic field as the magnetic field of the earth as an example, as shown in FIG. 5 to FIG. 8, FIG. 5 is a schematic diagram of a scenario of rotation with a photocathode of the photomultiplier tube in a fixed direction (that is, the dashed line in FIG. 5 is used as the rotation axis and rotation is performed around the rotation axis), and in FIG. 5, a direction of the magnetic field of the earth is from north to south, and the electron multiplication direction is from the photocathode to an anode. In this scenario, the relative angle of the electron multiplication direction and the direction of the magnetic field of the earth remains substantially constant as the photomultiplier tube rotates about the rotation axis. FIG. 6 is a schematic diagram of a scenario of rotation with the photocathode in a changed direction (that is, the dashed line in FIG. 6 is used as the rotation axis and rotation is performed around the rotation axis), and in FIG. 6, the direction of the magnetic field of the earth is from north to south. In this scenario, the relative angle of the electron multiplication direction and the direction of the magnetic field of the earth is changed as the photomultiplier tube rotates about the rotation axis. FIG. 7 is a change graph of the relative output of the photomultiplier tube at different rotation angles measured under the scenario of FIG. 5, FIG. 8 is a change graph of the relative output of the photomultiplier tube at different rotation angles measured under the scenario of FIG. 6, and in FIG. 7 and FIG. 8, the shown Gain curve indicates a relative gain, and ER represents an energy resolution change.

In practical applications, the scenario in FIG. 6 better conforms to a multi-pose detection use scenario of the detector in the SPECT system, the internal photomultiplier tube cuts the magnetic field of the earth in a probe rotation process, and the transmission path of the photocurrent between dynodes is influenced by the magnetic field of the earth and gradually shifts, so that the output of the photomultiplier tube is influenced. Thus, by comparing FIG. 7 and FIG. 8, it can be seen that when the electron multiplication direction of the photomultiplier tube changes relative to the direction of the magnetic field of the earth (for example, from FIG. 5 to FIG. 6), since the relative angle between the electron multiplication direction and the direction of the magnetic field of the earth changes continuously when the photomultiplier tube rotates around the dotted rotation axis, the relative output of the photomultiplier tube changes greatly. Thus, the angle data in the present application may include the relative angle of the electron multiplication direction of the photomultiplier tube and the direction of the magnetic field of the earth, for example, the geometric angle between the electron multiplication direction inside the PMT and the geomagnetic field direction (e.g., north-south direction). As can be seen from FIG. 6, when the photomultiplier tube rotates around the rotation axis thereof, the relative angle between the electron multiplication direction and the direction of the magnetic field of the earth also has a certain corresponding relationship to the rotation angle of the photomultiplier tube, and therefore, the angle data may also include the rotation angle of the photomultiplier tube, for example, the mechanical rotation angle around the preset rotation axis of the detector (e.g., the dashed axis in FIGS. 5 and 6) when the PMT rotates with the SPECT detector.

In practical applications, when the photomultiplier tube in the SPECT system is initialized and calibrated, the direction of the magnetic field of the earth can be used as a reference direction to zero the photomultiplier tube, so that the angle of the photomultiplier tube can be directly used as the angle data of the photomultiplier tube after being measured by an angle sensor, or the like.

S304: outputting a voltage compensation signal to an adjustable power supply circuit according to the angle data; the voltage compensation signal is used for instructing the adjustable power supply circuit to adjust a supply voltage output to each photomultiplier tube, so as to cause an output amplitude of the photomultiplier tube to reach an expected output amplitude.

The voltage compensation signal is a control signal calculated by the controller according to the relative angle data of the PMT and the environmental magnetic field collected by the angle sensor. This signal is sent to the adjustable power supply circuit and used for instructing the circuit to adjust the supply voltage provided for the PMT. The voltage compensation signal can adjust the supply voltage to compensate the change of the output signal of the PMT caused by the change of the environmental magnetic field, so that the output signal of the PMT can be kept stable under different poses. In short, the voltage compensation signal is a dynamic adjustment mechanism for correcting an output deviation caused by a pose change of the PMT in real time. The output amplitude of the PMT refers to intensity of an electrical signal produced by the PMT after the PMT receives a nuclear radiation signal with particular intensity. The expected output amplitude of the PMT refers to intensity of a standard output signal of the PMT for the same input signal in the absence of external disturbing factors such as the change in the magnetic field of the earth. Specifically, the expected output amplitude is a standard value predetermined according to a characteristic curve of the PMT and a system design target, and this value reflects an output performance of the PMT under an optimal working state. In practical applications, it is desirable that the output amplitude of the PMT should be constant, that is, achieve the expected output amplitude, for the same input signal regardless of the pose of the PMT.

Exemplarily, for the photomultiplier tube that is zeroed with the direction of the environmental magnetic field as the reference direction, the angle of the photomultiplier tube may be monitored in real time by the angle sensor (e.g., gyroscope) mounted on the detector, that is, the relative angle between the electron multiplication direction of the photomultiplier tube and the direction of the environmental magnetic field may be directly known, and the angle data may be transmitted to the controller. The controller calculates the corresponding voltage compensation signal according to a preset algorithm and early calibration data. For example, when the PMT rotates from a position perpendicular to the magnetic field of the earth to a parallel position, the controller calculates a value of the supply voltage to be adjusted based on the angle data provided by the angle sensor. The controller then sends the voltage compensation signal to the adjustable power supply circuit to instruct the circuit to adjust the supply voltage provided for the PMT. In this way, the amplitude of the output signal of the PMT can be kept within a desired range even though the PMT is in different poses, thereby ensuring imaging quality and diagnostic accuracy of the SPECT system. For example, assuming that the output amplitude of the PMT perpendicular to the magnetic field of the earth is 100 units, the uncompensated output amplitude may drop to 80 units at the parallel position, and the output amplitude may be adjusted back to 100 units by voltage compensation to achieve the expected output amplitude.

In the supply voltage gain compensation method for a photoelectric detection element of a detector, based on the relative angle between the photomultiplier tube and the environmental magnetic field, in combination with the preset algorithm and the early calibration data, the voltage compensation signal is calculated and instructs the adjustable power supply circuit to adjust the supply voltage, so that the output amplitude of the PMT is kept in the expected range, and real-time compensation of the output signals of the PMT under different poses is realized. The influence of the change of the magnetic field of the earth on the output signal of the PMT is effectively overcome, stability and consistency of the output signals of the PMT under different poses are ensured, and the imaging quality and the diagnosis accuracy of the SPECT system are improved. In addition, the solution also simplifies a system design, enhances reliability and robustness of the system, and provides higher-quality image data support for clinical applications.

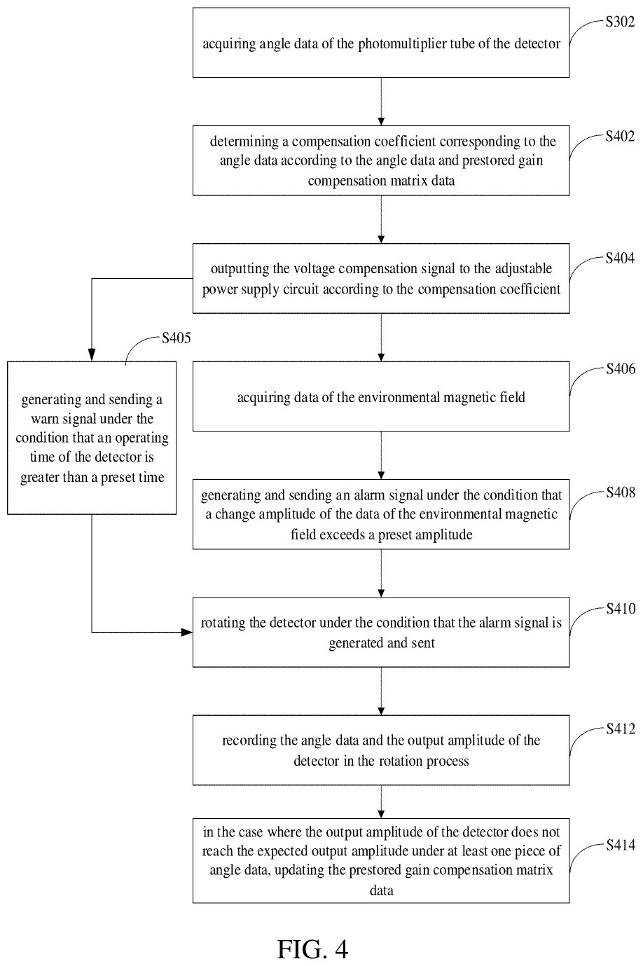

In an exemplary embodiment, as shown in FIG. 4, outputting the voltage compensation signal to the adjustable power supply circuit according to the angle data includes:

S402: determining a compensation coefficient corresponding to the angle data according to the angle data and prestored gain compensation matrix data; the gain compensation matrix data is used for representing a mapping relationship between the angle data and the compensation coefficient.

The compensation coefficient is a value reflecting a deviation of the output signal of the PMT at a certain angle, and is used to instruct the adjustable power supply circuit to adjust the supply voltage to counteract the influence of the change of the magnetic field of the earth on the output signal of the PMT. The gain compensation matrix data is a data table stored in the controller for representing the mapping relationship between the angle data and the compensation coefficient. The data table may be obtained through experimental calibration in the system initialization or calibration stage, and records a change rule of the output signal of the PMT at different angles.

Taking the angle data including the rotation angle of the photomultiplier tube as an example for explanation, the specific experimental calibration process may be as follows: in the environment of the SPECT system, the environmental magnetic field thereof is mainly the magnetic field of the earth, and the magnetic field of the earth is basically kept unchanged at a same longitude and latitude position within a period of time (such as a quarter), so that data of the magnetic field of the earth of each quarter can be directly obtained from scientific research institutions and meteorological departments, and is stored in the controller, and in the system initialization or calibration stage, with the stored data of the magnetic field of the earth as a reference, the detector is rotated according to a preset angle step (such as 5 degrees or 10 degrees) through an experimental calibration method, and the amplitude of the output signal of the PMT at each rotation angle of the photomultiplier tube is recorded. Meanwhile, a standard signal source is used to provide consistent nuclear radiation input, thus ensuring that input conditions for each measurement are the same. Gain compensation coefficients at the angles are calculated by calculating differences between the amplitudes of the output signals at different angles and standard output amplitudes. These gain compensation coefficients are stored in a memory of the controller together with the corresponding angle data to form the gain compensation matrix data, as shown in table 1 below:

TABLE 1

| Angle (°) | PMT1 | PMT2 | PMT3 | . . . | PMT(n − 2) | PMT(n − 1) | PMT(n) | PMT(n + 1) | PMT(n + 2) |
|---|---|---|---|---|---|---|---|---|---|
| 0 | (a₁₋₁, | (a₂₋₁, | (a₃₋₁, | . . . | (aₙ₋₂₋₁, | (aₙ₋₁₋₁, | (aₙ₋₁, | (aₙ₊₁₋₁, | (aₙ₊₂₋₁, |
| | b₁₋₁) | b₂₋₁) | b₃₋₁) | | bₙ₋₂₋₁) | bₙ₋₁₋₁) | bₙ₋₁) | bₙ₊₁₋₁) | bₙ₊₂₋₁) |
| 10 | (a₁₋₂, | (a₂₋₂, | (a₃₋₂, | . . . | (aₙ₋₂₋₂, | (aₙ₋₁₋₂, | (aₙ₋₂, | (aₙ₊₁₋₂, | (aₙ₊₂₋₂, |
| | b₁₋₂) | b₂₋₂) | b₃₋₂) | | bₙ₋₂₋₂) | bₙ₋₁₋₂) | bₙ₋₂) | bₙ₊₁₋₂) | bₙ₊₂₋₂) |
| 20 | (a₁₋₃, | (a₂₋₃, | (a₃₋₃, | . . . | (aₙ₋₂₋₃, | (aₙ₋₁₋₃, | (aₙ₋₃, | (aₙ₊₁₋₃, | (aₙ₊₂₋₃, |
| | b₁₋₃) | b₂₋₃) | b₃₋₃) | | bₙ₋₂₋₃) | bₙ₋₁₋₃) | bₙ₋₃) | bₙ₊₁₋₃) | bₙ₊₂₋₃) |
| 30 | (a₁₋₄, | (a₂₋₄, | (a₃₋₄, | . . . | (aₙ₋₂₋₄, | (aₙ₋₁₋₄, | (aₙ₋₄, | (aₙ₊₁₋₄, | (aₙ₊₂₋₄, |
| | b₁₋₄) | b₂₋₄) | b₃₋₄) | | bₙ₋₂₋₄) | bₙ₋₁₋₄) | bₙ₋₄) | bₙ₊₁₋₄) | bₙ₊₂₋₄) |
| . . . | . . . | . . . | . . . | . . . | . . . | . . . | . . . | . . . | . . . |
| 170 | (a₁₋₁₇, | (a₂₋₁₇, | (a₃₋₁₇, | . . . | (aₙ₋₂₋₁₇, | (aₙ₋₁₋₁₇, | (aₙ₋₁₇, | (aₙ₊₁₋₁₇, | (aₙ₊₂₋₁₇, |
| | b₁₋₁₇) | b₂₋₁₇) | b₃₋₁₇) | | bₙ₋₂₋₁₇) | bₙ₋₁₋₁₇) | bₙ₋₁₇) | bₙ₊₁₋₁₇) | bₙ₊₂₋₁₇) |
| 180 | (a₁₋₁₈, | (a₂₋₁₈, | (a₃₋₁₈, | . . . | (aₙ₋₂₋₁₈, | (aₙ₋₁₋₁₈, | (aₙ₋₁₈, | (aₙ₊₁₋₁₈, | (aₙ₊₂₋₁₈, |
| | b₁₋₁₈) | b₂₋₁₈) | b₃₋₁₈) | | bₙ₋₂₋₁₈) | bₙ₋₁₋₁₈) | bₙ₋₁₈) | bₙ₊₁₋₁₈) | bₙ₊₂₋₁₈) |

In the table, PMT1, PMT2, PMT3, . . . , PMT (n-2), or the like, respectively represent different photomultiplier tubes in a photomultiplier tube array; (a₁₋₁, b₁₋₁), (a₂₋₁, b₂₋₁), or the like, respectively represent compensation coefficients corresponding to different photomultiplier tubes under different angles. The data is stored in the gain compensation matrix, so that in actual operation, the corresponding compensation coefficient can be quickly searched and applied according to the real-time angle data to ensure that the output signals of the PMT are kept stable under different poses.

S404: outputting the voltage compensation signal to the adjustable power supply circuit according to the compensation coefficient.

The determination of the voltage compensation signal may be based on finding in a mapping table or calculation through an expression. The manner is not restricted, and the finding in the mapping table can save computing resources and improve a response efficiency. The voltage compensation signal calculated based on the expression can save storage resources, and the manner can be specifically selected according to actual application scenarios. In an optional embodiment, the two manners may coexist to increase execution reliability of the method, and when the mapping table is lost, the voltage compensation signal may be calculated based on the expression to direct the adjustable power supply circuit to perform voltage compensation.

In an embodiment, after the corresponding compensation coefficient is determined from the gain compensation matrix data based on the angle data, the voltage compensation signal may be further determined based on a gain relation code=10\hat{ }(a*HV−b), code is a target output gain; a and b are the compensation coefficients which are different for different photomultiplier tubes in the photomultiplier tube array under different angle data, and for details, reference may be made to table 1 in the above embodiment; HV is the voltage compensation signal.

Based on the above gain relation, in an embodiment, the step S404 may include: determining and outputting the voltage compensation signal to the adjustable power supply circuit according to the compensation coefficient and the following expression:

$$HV = ( Log ( code ) + b ) / a .$$

In an embodiment, a mapping relationship table of the compensation coefficient, the voltage compensation signal and the angle data may be constructed in advance, as shown in table 2 below:

TABLE 2

| | Gain before | Gain after | Voltage |
|---|---|---|---|
| | correction | correction | compensation signal |
| Angle (°) | code | code | HV |
| 0 | 340.08 | 350 | (Log(350) + b₁)/a₁ |
| 10 | 342.02 | 350 | (Log(350) + b₂)/a₂ |
| 20 | 345.29 | 350 | (Log(350) + b₃)/a₃ |
| 30 | 350.55 | 350 | (Log(350) + b₄)/a₄ |
| 40 | 352.88 | 350 | (Log(350) + b₅)/a₅ |
| 50 | 360.55 | 350 | (Log(350) + b₆)/a₆ |
| 60 | 365.07 | 350 | (Log(350) + b₇)/a₇ |
| 70 | 368.01 | 350 | (Log(350) + b₈)/a₈ |

As shown in table 2, after it is determined that the compensation coefficients when the angle data of one photomultiplier tube is 0° are a1 and b1, the corresponding voltage compensation signal HV may be determined based on the target output gain (i.e., corrected gain code, e.g., 350). At other angles, the corresponding voltage compensation signal HV may also be determined based on a similar process.

Exemplarily, based on the gain compensation matrix data, the relationship between the relative angle of the photomultiplier tube and the environmental magnetic field and the change of the output signal thereof is established. In the system operation process, the controller inquires the gain compensation matrix data according to the real-time angle data provided by the angle sensor, and quickly searches and determines the corresponding compensation coefficient, so as to generate the voltage compensation signal, and dynamically adjust the supply voltage of the photomultiplier tube, thus ensuring the consistency and stability of the output signal of the photomultiplier tube under different poses.

In this embodiment, the influence of the change of the magnetic field of the earth on the output signal of the photomultiplier tube is effectively overcome by constructing the gain compensation matrix data and applying the gain compensation coefficient in real time in the system operation process. Specifically, this effect is achieved based on the gain compensation matrix data formed by performing detailed experimental calibration in the system initialization or calibration stage and recording the change rule of the output signal of the photomultiplier tube at different angles. In actual operation, the controller queries the gain compensation matrix data according to the real-time angle data provided by the angle sensor, rapidly determines the corresponding compensation coefficient, generates the voltage compensation signal, and dynamically adjusts the supply voltage of the photomultiplier tube, thus ensuring the stability and consistency of the output signal of the photomultiplier tube in different poses, improving the imaging quality and diagnosis accuracy of the SPECT system, enhancing the reliability and robustness of the system, and providing the higher-quality image data support for the clinical applications.

In an exemplary embodiment, as shown in FIG. 4, the method further includes: S405: generating and sending a warn signal under the condition that an operating time of the detector is greater than a preset time; S406: acquiring data of the environmental magnetic field; and S408: generating and sending a warn signal under the condition that a change amplitude of the data of the environmental magnetic field exceeds a preset amplitude.

The change amplitude of the data of the environmental magnetic field refers to a change amount of the environmental magnetic field in a certain time. The data of the environmental magnetic field is, for example, the magnetic field strength and the magnetic field direction of the environmental magnetic field. In particular, the change amplitude is a difference between currently measured intensity of the environmental magnetic field and previously recorded intensity of the environmental magnetic field. The change amplitude is used to monitor stability of the environmental magnetic field. If the change amplitude is large, it may indicate that the environmental magnetic field has a sudden change, which may affect the output signal of the photomultiplier tube. The preset amplitude is a threshold for judging whether the change in the environmental magnetic field is within an acceptable range, and the threshold can be set according to experimental data and experience during a system design stage. The operating time of the detector refers to an accumulated working time of the detector from beginning of working to a current time. The preset time is a time threshold for judging whether the detector needs to be periodically calibrated, and the threshold may be set during the system design stage according to an expected service life and a maintenance period of a device. Specifically, as described in the above embodiment, since the magnetic field of the earth is substantially constant at the same longitude and latitude position for a period of time (e.g., quarter), the preset time may also be set based on a change period of the magnetic field of the earth to determine the change of the magnetic field of the earth in a time dimension.

Exemplarily, during an initial stage of the system operation, the data of the environmental magnetic field of the environment in which the SPECT system is located for a period of time may be collected by a Hall sensor and compared with data of the environmental magnetic field previously stored in the controller to determine stability of the magnetic field for the period of time. When the change amplitude of the data of the environmental magnetic field exceeds the preset amplitude, it indicates that the environmental magnetic field is suddenly changed, and the controller can generate and send the warn signal to inform operators and prompt the operators to check whether the environmental magnetic field is abnormal. In particular, it is assumed that there are multiple Hall sensors distributed at different locations in the SPECT system, each sensor having its own preset amplitude (e.g., 0.1 Tesla). If one of the sensors detects a change in the environmental magnetic field from 0.3 Tesla to 0.4 Tesla, the change amplitude is 0.1 Tesla, and the controller generates the warn signal and sends the signal to the operators to prompt the operators to check whether the environmental magnetic field in the region is abnormal. In addition, the change condition of the magnetic field of the earth can be determined in the time dimension by judging whether the operating time of the detector reaches the preset time. Assuming that the preset time is 3 months (one quarter), and the controller records the information that the accumulated operating time of the detector reaches 3 months, the controller generates the warn signal and sends the signal to the operators to prompt the operators to perform periodic maintenance and calibration, so as to ensure long term stability and performances of the system. Since the magnetic field of the earth remains substantially constant in the same quarter, a correction every 3 months can effectively account for the potential change of the environmental magnetic field.

In this embodiment, by acquiring the data of the environmental magnetic field in real time, functions of real-time monitoring and warning of the change of the environmental magnetic field are realized. Specifically, the data of the environmental magnetic field is collected in real time, and the controller judges whether the change amplitude exceeds the preset amplitude by comparing a current measurement value with the prestored data of the environmental magnetic field. If the amplitude exceeds the preset amplitude, the controller can generate and send the warn signal to prompt the operator to check whether the environmental magnetic field is abnormal. In addition, the accumulated operating time of the detector is recorded, and when the operating time exceeds the preset time, the warn signal is generated and sent to remind the operator to perform regular maintenance and correction, so that the sudden change of the environmental magnetic field can be found and handled in time, the stability and the reliability of the system in long-time operation can be ensured, and the imaging quality and the diagnosis accuracy of the SPECT system are improved.

In an exemplary embodiment, as shown in FIG. 4, the method further includes: S410: rotating the detector under the condition that the warn signal is generated and sent; S412: recording the angle data and the output amplitude of the photomultiplier tube in the rotation process; and S414: in the case where the output amplitude of the photomultiplier tube does not reach the expected output amplitude under at least one piece of angle data, updating the prestored gain compensation matrix data.

Exemplarily, when the controller generates and sends the warn signal, it indicates that the data of the environmental magnetic field of the environment in which the SPECT system is located has a sudden change, and the mapping relationship between the angle data of the photomultiplier tube and the gain compensation coefficient needs to be re-corrected, that is, the prestored gain compensation matrix data is updated. Reference may be made to the calibration process of the gain compensation matrix data in the above embodiment for the updating process of the gain compensation matrix data which is not repeated herein until the updated gain compensation matrix data enables the output amplitude of the photomultiplier tube to reach the expected output amplitude under any angle data.

In this embodiment, dynamic update of the gain compensation matrix data is achieved by automatically rotating the detector and recording the angle data and the output amplitude of the photomultiplier tube during rotation under the condition of generating and sending the warn signal. Specifically, when the environmental magnetic field changes suddenly or the operating time of the detector exceeds the preset time, the controller generates and sends the warn signal and starts an automatic correction process. The detector is rotated, and the controller records the output amplitudes at different angles, and updates the prestored gain compensation matrix data when finding that the output amplitude at any angle fails to reach an expected value, thereby ensuring that the output signal of the PMT can still be kept stable and accurate after an environmental change or long-time operation, improving a self-adaption capability and long-term stability of the SPECT system, and improving the imaging quality and the diagnosis accuracy of the system.

In an exemplary embodiment, as shown in FIG. 9, the present application provides a supply voltage gain compensation module applied to a detector of a SPECT system, the supply voltage gain compensation module including an angle sensor 2, an adjustable power supply circuit 4, and a controller 6. The angle sensor 2 is configured to collect angle data of a photomultiplier tube 700 of the detector; the angle data is used for representing a relative angle between the photomultiplier tube 700 and an environmental magnetic field; the adjustable power supply circuit 4 is configured to provide a supply voltage for each photomultiplier tube 700; the controller 6 is connected to the angle sensor 2 and the adjustable power supply circuit 4 respectively, and the controller 6 is configured to acquire the angle data and output a voltage compensation signal to the adjustable power supply circuit 4 according to the angle data; the voltage compensation signal is used for instructing the adjustable power supply circuit 4 to adjust the supply voltage output to each photomultiplier tube 700, so as to cause an output amplitude of the photomultiplier tube to reach an expected output amplitude.

For meanings of the environmental magnetic field, the angle data, the output amplitude and the expected output amplitude of the photomultiplier tube, and the voltage compensation signal in the gain compensation module, and a specific implementation process of the gain compensation module, reference may be made to the description in the embodiment of the supply voltage gain compensation method for a photoelectric detection element of a detector, and details are not repeated here.

The gain compensation module realizes real-time compensation of the output signals of the photomultiplier tube under different poses through the angle sensor, the adjustable power supply circuit and the controller. Specifically, the angle sensor (e.g., gyroscope) monitors the relative angle of the photomultiplier tube and the environmental magnetic field in real time and transmits the data to the controller. The controller calculates the voltage compensation signal according to the angle data in combination with a preset algorithm and early calibration data, and instructs the adjustable power supply circuit to adjust the supply voltage, so as to cause the output amplitude of the photomultiplier tube to be kept in the expected range. This solution effectively overcomes an influence of a change of a magnetic field of the earth on the output signal of the photomultiplier tube, ensures stability and consistency of the output signals of the PMT under different poses, and improves imaging quality and diagnosis accuracy of the SPECT system. In addition, the solution also simplifies a system design, enhances reliability and robustness of the system, and provides higher-quality image data support for clinical applications.

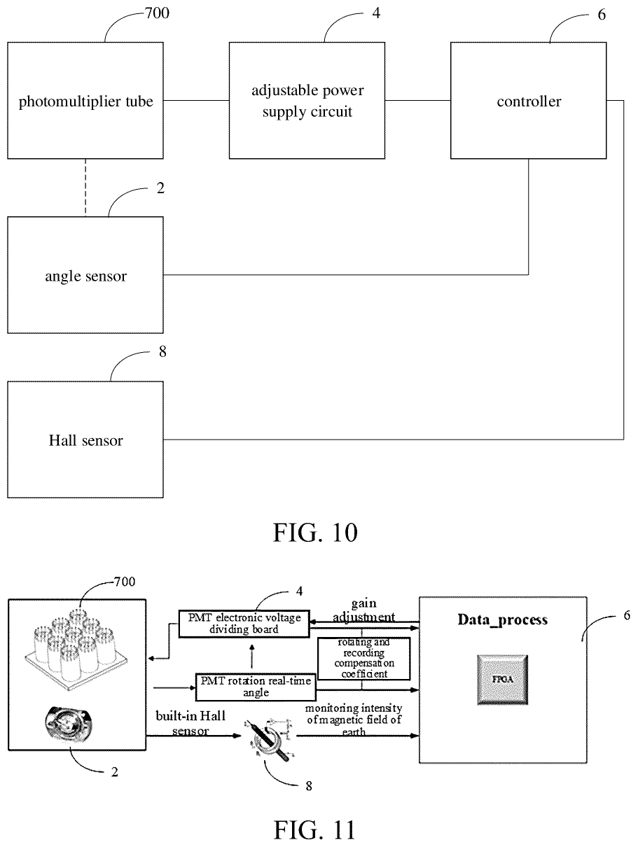

In an exemplary embodiment, as shown in FIG. 10, the compensation module further includes a Hall sensor 8. The Hall sensor 8 is configured to collect data of the environmental magnetic field; the controller 6 is connected to the Hall sensor 8, and the controller 6 is configured to acquire the data of the environmental magnetic field and generate and send an warn signal under the condition that a change amplitude of the data of the environmental magnetic field exceeds a preset amplitude or an operating time of the detector is greater than a preset time.

In this embodiment, for meanings of the change amplitude of the data of the environmental magnetic field, the preset amplitude and a specific implementation process in this embodiment, reference may be made to the description in the method embodiment above, and details are not repeated here.

In this embodiment, the Hall sensor is introduced to achieve functions of real-time monitoring and warning of the change of the environmental magnetic field. Specifically, the Hall sensor collects the data of the environmental magnetic field in real time, and the controller judges whether the change amplitude exceeds the preset amplitude by comparing a current measurement value with prestored data of the environmental magnetic field. If the amplitude exceeds the preset amplitude, the controller can generate and send the warn signal to prompt an operator to check whether the environmental magnetic field is abnormal. In addition, the controller further records accumulated operating time of the detector, and when the operating time exceeds the preset time, generates and sends the warn signal to remind the operator to perform regular maintenance and correction, so that the sudden change of the environmental magnetic field can be found and handled in time, stability and reliability of the system in long-time operation can be ensured, and the imaging quality and the diagnosis accuracy of the SPECT system are improved.

In an exemplary embodiment, the angle sensor 2 is a gyroscope, and the gyroscope has a consistent pose with the photomultiplier tube 700.

In this embodiment, the angle sensor is the gyroscope, and the gyroscope and the photomultiplier tube have the consistent pose, which ensures that the gyroscope can accurately measure the relative angle between the photomultiplier tube and the environmental magnetic field, thereby providing accurate angle data for the controller. Through real-time monitoring and feedback, the controller can dynamically adjust the supply voltage of the PMT according to the angle data, which ensures that the output signals of the PMT under different poses are kept stable and consistent, thus improving the imaging quality and the diagnosis accuracy of the SPECT system, and ensuring long-term stable operation under complex environment conditions.

Real-time compensation of the output signals of the PMT under different poses is realized through the angle sensor, the adjustable power supply circuit and the controller. Specifically, the angle sensor (e.g., gyroscope) monitors the relative angle of the PMT and the environmental magnetic field in real time and transmits the data to the controller. The controller calculates the voltage compensation signal according to the angle data in combination with the preset algorithm and the early calibration data, and instructs the adjustable power supply circuit to adjust the supply voltage, so as to cause the output amplitude of the PMT to be kept in the expected range. This solution effectively overcomes the influence of the change of the magnetic field of the earth on the output signal of the PMT, ensures the stability and the consistency of the output signals of the PMT under different poses, and improves the imaging quality and the diagnosis accuracy of the SPECT system. In addition, the solution also simplifies the system design, enhances the reliability and the robustness of the system, and provides the higher-quality image data support for the clinical applications.

In order to describe the technical solution of the present application in more detail, the following detailed description is made with reference to FIG. 11. The gain compensation module according to the present application includes the angle sensor 2 (such as a gyroscope), the adjustable power supply circuit 4 (such as a PMT electronic voltage dividing board) and the controller 6 (including a gain compensation circuit and a logic correction unit), the gyroscope measures the angle of the photomultiplier tube 700 relative to the magnetic field of the earth, and real-time gain compensation is performed through back-end electronic logic processing, so that the traditional mechanical magnetic shielding structure is not needed, the PMT array is denser, and a performance and stability of a device are further improved. Specific functions of the components are as follows.

Gyroscope: since the angle of the PMT relative to the magnetic field of the earth is changed during rotation of the detector, output influences of different angle positions are different, and different angle positions and output signal amplitudes are recorded through the gyroscope, so that output deviation values of different angle positions are obtained. The gyroscope as the angle sensor 2 has a small volume and high accuracy, and can simplify the design to a certain extent and achieve the purpose of high-accuracy angle detection.

Gain compensation circuit: the gyroscope detects the angle data, and the output of the PMT is compensated through a gain adjusting circuit according to the recorded output deviation value under the corresponding angle, so that the influence of the magnetic field of the earth on the output is counteracted. The gain compensation manner replaces the bulky structural mode of the traditional magnetic shielding can, and a mechanical structure design can be simplified to a certain extent, thus making assembly denser, reducing the dead zones between the PMTs, and improving the performance and stability.

Hall sensor 8: the magnetic field of the earth is related to seasons according to related literatures, and usually, in a period of time, the magnetic field of the earth is basically kept unchanged at the same longitude and latitude position, the overall magnetic field of the earth is monitored through the Hall sensor 8, an abrupt change value is recorded, and when the change of the environmental magnetic field is monitored and is continuous, one angle correction needs to be performed on the detector, angle gain deviation data is recorded again, or the related coefficient is obtained through a change amount of the overall magnetic field for overall compensation. The Hall sensor 8 is used for monitoring the change of the overall magnetic field, so that a dynamic adjusting function of gain compensation is compensated to a certain extent, the change of the environmental magnetic field can be monitored in real time, and the overall monitoring and correcting system is more perfect and reliable.

Logic correction unit: the logic correction unit includes a core processing chip (such as an FPGA), a flash, or the like, the gain compensation matrix data, or the like, need to be recorded, and data monitoring and corresponding gain correction processing are performed in the real-time rotation process of the detector, so as to weaken or eliminate the influence of the magnetic field of the earth on the output signal of the PMT.

The specific implementation process is as follows: the gyroscope and the Hall sensor 8 are integrated in the detector, the logic correction unit acquires data of the Hall sensor 8 through real-time monitoring at the initial stage of the operation of the SPECT system, the data is data of the environmental magnetic field recorded within a period of time, the magnetic field stability within the period of time is judged through an early-stage set judgment logic, and whether an angle correction needs to be performed again is determined. When it is determined that the correction needs to be performed again based on the data obtained from the Hall sensor 8, or when time setting for the device operation is reached, an angle correction flow is started: operating the device-rotating the detector according to a designated step-recording the angle data of the gyroscope and the output amplitude of the PMT-obtaining the gain compensation coefficients under different angles and forming the gain compensation matrix data representing the mapping relationship between the angle data and the gain compensation coefficients-recording the gain compensation matrix data in the flash for the real-time correction. After the angle correction operation is finished, based on the recorded gain compensation coefficients at different angles, the gain compensation coefficient at the corresponding angle is determined by obtaining the angle data collected by the gyroscope in real time, and an output gain of the PMT is adjusted by adjusting the supply voltage of the PMT in real time through the gain adjusting circuit, so as to offset the influence brought by the magnetic field of the earth.

In an exemplary embodiment, the present application also provides a SPECT system including a detector and the gain compensation module according to the above embodiment.

It should be understood that, although the steps in the flow charts involved in the above embodiments are shown in sequence as indicated by the arrows, the steps are not necessarily performed in sequence as indicated by the arrows. Unless explicitly stated herein, the steps are not limited to being performed in the exact order and may be performed in other orders. At least part of the steps in the flow charts involved in the above embodiments may include multiple steps or multiple stages, which are not necessarily performed at the same moment, but may be performed at different moments, and the steps or the stages are not necessarily performed in sequence, but may be performed alternately with other steps or at least part of the steps or the stages in other steps.

Based on the same inventive concept, the embodiment of the present application further provides a gain compensation apparatus for implementing the above supply voltage gain compensation method for a photoelectric detection element of a detector. The implementation solution for solving problems provided by the apparatus is similar to the implementation solution described in the above method, and therefore, for the specific definitions in one or more embodiments of the gain compensation apparatus provided below, reference can be made to the definitions of the gain compensation method in the above description, and the definitions are not repeated herein.

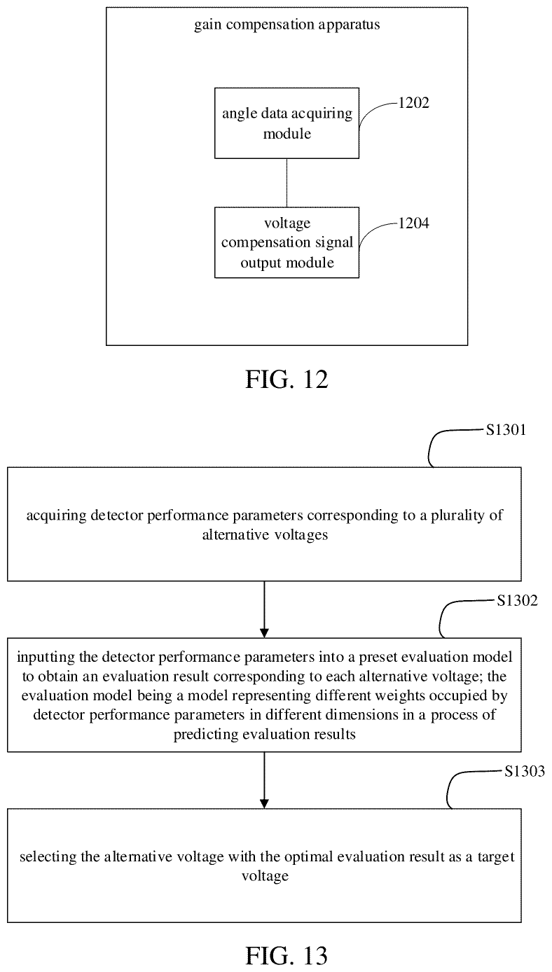

In an exemplary embodiment, as shown in FIG. 12, there is provided a gain compensation apparatus, including: an angle data acquiring module 1202 configured to acquire angle data of a photomultiplier tube; the angle data being used for representing a relative angle between the photomultiplier tube and an environmental magnetic field; and a voltage compensation signal output module 1204 configured to output a voltage compensation signal to an adjustable power supply circuit according to the angle data; the voltage compensation signal is used for instructing the adjustable power supply circuit to adjust a supply voltage output to each photomultiplier tube, so as to cause an output amplitude of the photomultiplier tube to reach an expected output amplitude.

In an exemplary embodiment, the voltage compensation signal output module 1204 includes: a compensation coefficient determining unit configured to determine a compensation coefficient corresponding to the angle data according to the angle data and prestored gain compensation matrix data; and a voltage compensation signal output unit configured to output the voltage compensation signal to the adjustable power supply circuit according to the compensation coefficient; the gain compensation matrix data is used for representing a mapping relationship between the angle data and the compensation coefficient.

In an exemplary embodiment, the voltage compensation signal output unit includes: a voltage compensation signal determining unit configured to determine the voltage compensation signal according to the compensation coefficient, a target output gain and the following gain relation: code=10\hat{ }(a*HV−b); code is the target output gain; a and b are the compensation coefficients; and HV is the voltage compensation signal.

In an exemplary embodiment, the gain compensation apparatus further includes: a warn signal output module configured to generate and send a warn signal under the condition that an operating time of the detector is greater than a preset time.

In an exemplary embodiment, the gain compensation apparatus further includes: an environmental magnetic field data acquiring module configured to acquire data of the environmental magnetic field; and a warn signal output module configured to generate and send a warn signal under the condition that a change amplitude of the data of the environmental magnetic field exceeds a preset amplitude.

In an exemplary embodiment, the gain compensation apparatus further includes: a driving module configured to rotate the detector under the condition that the warn signal is generated and sent; a data recording module configured to record the angle data and the output amplitude of the photomultiplier tube in the rotation process; and an update module configured to, in the case where the output amplitude of the photomultiplier tube does not reach the expected output amplitude under at least one piece of angle data, update the prestored gain compensation matrix data.

The modules in the gain compensation apparatus may be wholly or partially implemented by software, hardware and a combination thereof. The modules may be embedded in or independent of the processor in the computer device in hardware, or may be stored in the memory in the computer device in software, such that the processor can conveniently call the modules to execute the operations corresponding to the modules.

Another embodiment of the present application further provides a target voltage determination method for a photoelectric detection element of a detector. In this embodiment, the detector may be a detector of a PET system or SPECT system. In the following description, for example, the detector is a PET detector, and the photoelectric detection element is, for example, a photomultiplier tube (PMT), and preferably a silicon photomultiplier (SiPM). As shown in FIG. 13, the method includes:

S1301: acquiring detector performance parameters corresponding to a plurality of alternative voltages. The plurality of alternative voltages may be determined based on common supply voltages of the PET detector, may be determined empirically by a user, or may be a plurality of alternative voltages obtained by incrementing and/or decrementing an initial voltage based on the initial voltage. In the following description, the supply voltage of the PET detector is the supply voltage of the photoelectric detection element of the PET detector. The alternative voltage selected in this way meets power supply requirements of the PET detector, and can be beneficial to increasing processing speeds of step S1302 and step S1303, thereby increasing a target voltage determination efficiency. The detector performance parameters can be obtained according to the NEMA2018 test method, and can also be obtained based on learning of a preset learning model.

S1302: inputting the detector performance parameters into a preset evaluation model to obtain an evaluation result corresponding to each alternative voltage. The detector performance parameters refer to parameters that can represent performances of the PET detectors when the PET detector is powered on, and may include, but are not limited to, a time of flight, an energy resolution, sensitivity, or the like. The preset evaluation model is a model capable of reflecting a mapping relationship between the detector performance parameters and the evaluation results. The preset evaluation model is a model representing different weights occupied by detector performance parameters in different dimensions in a process of predicting evaluation results. That is, the model can represent importance degrees of the detector performance parameters in various dimensions for evaluation of an overall performance of the PET detector when a doctor actually uses the PET detector. The evaluation result is information for representing the overall performance of the PET detector. A form of the evaluation result may include, but is not limited to, a score.

S1303: selecting the alternative voltage with the optimal evaluation result as a target voltage. The alternative voltage with the optimal evaluation result is the alternative voltage when the performance of the detector is optimal.

Specifically, the detector performance parameters corresponding to the multiple alternative voltages are obtained and input into the preset evaluation model to obtain the evaluation result corresponding to each alternative voltage, the evaluation results corresponding to the multiple alternative voltages are compared, and the alternative voltage with the optimal evaluation result is selected as the target voltage, so that the optimal performance of the PET detector is ensured under the condition that a power supply circuit of the PET detector outputs the target voltage to the photomultiplier tube.

For different voltages of the PET detector, changes of the detector performance parameters in the dimensions may not be linear, and the condition that when the time of flight is shortest, the energy resolution is not the highest exists, so that an evaluation process of the doctor can be simulated through the evaluation model provided in the embodiment of the application, and then, the optimal alternative voltage is selected from the plurality of alternative voltages as the target voltage. Compared with a traditional manual manner, the calculation process is quick and effective, a labor cost is reduced, and in addition, the condition that voltage determination results are uneven due to personal level differences of doctors is avoided, and then, consistency and reliability of the target voltage determination are improved.

Exemplarily, taking the alternative voltages including 40V, 40.5V, 41V, 41.5V, 42V, 42.5V, 43V, 43.5V, 44V, 44.5V, and 45V as an example for explanation, the detector performance parameters corresponding to these alternative voltages can be obtained according to the NEMA2018 test method. The detector performance parameters are input into the preset evaluation model, and the detector performance parameters in different dimensions occupy different weights in the process of predicting the evaluation results. For example, the weight of the time of flight may be 90%, the weight of the energy resolution may be 6%, and the weight of the sensitivity may be 4%. Based on the evaluation result predicted by the evaluation model under the weight, the alternative voltage with the optimal evaluation result is 42.5V, and then, 42.5V may be used as the target voltage for guiding power supply of the PET detector.

Optionally, the different weights occupied by the detector performance parameters in different dimensions in the process of predicting the evaluation results may be determined based on machine learning training or user-defined.

In an embodiment, the detector performance parameters include the time of flight, the energy resolution and the sensitivity.

The time of flight (TOF) refers to a time between generation of particles (e.g., generation of two photons from positron annihilation) and capturing of these particles by the detector, and the TOF is usually in nanoseconds (ns). In PET imaging, two gamma photons are generated almost simultaneously and fly in opposite directions. By measuring a difference of times (i.e., times of flight) when the two photons reach the detector, whether they are from a same annihilation event can be determined, thereby helping to determine a position where the annihilation occurs, which helps to improve a spatial resolution of an image and reduce background noise. In addition to the gamma photons from the annihilation event, noise from other sources such as scattered photons or cosmic rays is present during PET imaging, and can interfere with sharpness of the image. By reducing the time of flight, the detector can more accurately distinguish the gamma photons from the annihilation event from the background noise, thereby reducing influences of the noise on the image and improving a signal-to-noise ratio and a contrast of the image. Therefore, the shorter time of flight of the PET detector is better.

The energy resolution refers to an ability of the detector to distinguish between different energy particles, can be expressed as a ratio of a standard deviation of energy distribution measured by the detector to mean energy, is usually expressed in percent (%) and can also be expressed as a standard deviation of an energy unit (e.g., keV). In PET imaging, energy of the gamma photons is known (typically 511 keV), the detector needs to be able to accurately measure the energy of these photons to distinguish between the signal (i.e., the gamma photons from the annihilation event) and the background noise (such as the scattered photons or cosmic rays), the higher the energy resolution, the higher the ability of the detector to distinguish between the signal and the noise, and therefore, the higher energy resolution of the PET detector is better.

The sensitivity refers to the ability of the detector to detect particles, is typically expressed as a ratio of a number of the particles detected by the detector in a period of time to a number of incident particles, and is typically expressed in percent (%) or count rate (e.g., cps, i.e., counts per second). The high-sensitivity detector can capture more gamma photons, thereby improving statistical quality and the signal-to-noise ratio of the image, and therefore, the higher sensitivity of the PET detector is better.

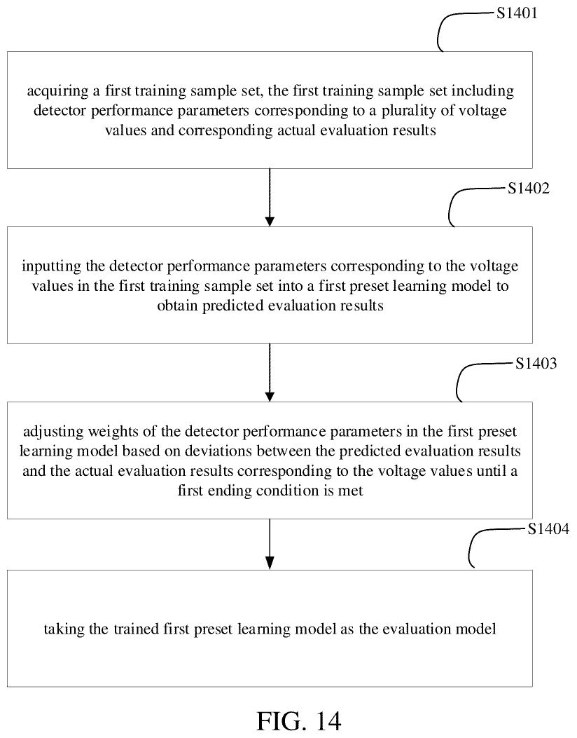

In an embodiment, as shown in FIG. 14, a training process of the preset evaluation model includes:

S1401: acquiring a first training sample set, the first training sample set including detector performance parameters corresponding to a plurality of voltage values and corresponding actual evaluation results. The actual evaluation result can be an evaluation result fed back by a user who uses the PET detector clinically, and can represent a dimension of the performance of the PET detector to which the user pays more attention when using the PET detector.

S1402: inputting the detector performance parameters corresponding to the voltage values in the first training sample set into a first preset learning model to obtain predicted evaluation results. The first preset learning model may be a deep learning model, an AI model, or the like, and may be another model. For example, the first preset learning model may include a normalization model and a weight-based scoring model, the normalization model is configured to normalize detector performance parameters in multiple dimensions, and then input the normalized results into the weight-based scoring model, and the scoring model may be: Y=Σ(Ki*Xi); Y is the evaluation result, Ki is the weight of the detector performance parameter with the ith dimension, and Xi is the normalized result of the detector performance parameter with the ith dimension. Taking the detector performance parameters including the time of flight, the energy resolution, and the sensitivity as an example, the weight of the time of flight may be greater than the weight of the energy resolution, and the weight of the energy resolution may be greater than the weight of the sensitivity.

S1403: adjusting weights of the detector performance parameters in the first preset learning model based on deviations between the predicted evaluation results and the actual evaluation results corresponding to the voltage values until a first ending condition is met.

When the first preset learning model is different, the weight is understood differently. For example, when the first preset learning model is a deep learning model, the weight represents connection strength of different neurons of a neural network, and determines a contribution of the input data to output of the deep learning model. The first ending condition may be set according to the selected first preset learning model. For example, the first ending condition may mean that a preset maximum iterative training time number is reached, or the deviation between the predicted evaluation result and the actual evaluation result corresponding to the voltage value is within a preset deviation range, or training samples in the first sample training set are traversed. The preset deviation range may be determined based on clinical use requirements.

S1404: taking the trained first preset learning model as the evaluation model.

The evaluation model trained based on the above steps can represent real requirements of the doctor on the detector performance parameters in clinic, and can ensure that the evaluation result obtained based on the evaluation model can be matched with an evaluation of the doctor on the PET detector in clinic. For example, in a possible implementation, the weight of the time of flight is 90%, the weight of the energy resolution is 7%, and the weight of the sensitivity is 3%.

In an embodiment, the weight of the time of flight is greater than the weight of the energy resolution, and the weight of the energy resolution is greater than or equal to the weight of the sensitivity.

In the training process of the evaluation model, the principle that the weight of the time of flight is larger than the weight of the energy resolution and the weight of the energy resolution is larger than the weight of the sensitivity is followed, and conforms to consideration importance degrees of the multi-dimensional performance parameters when the doctor evaluates the overall performance of the PET detector clinically, and the trained evaluation model can be ensured to be close to the real evaluation of the doctor. Therefore, it can be ensured that when the target voltage determined based on the evaluation model is loaded on the PET detector, the time of flight of the PET detector is short, and the energy resolution and the sensitivity are high.

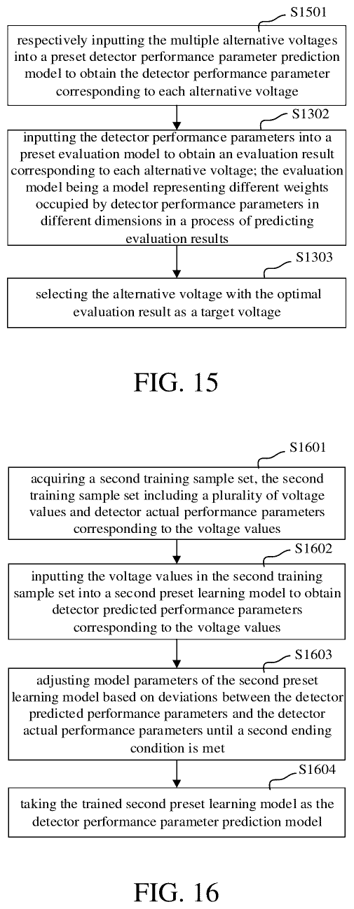

In an embodiment, as shown in FIG. 15, the step S1301 of acquiring detector performance parameters corresponding to a plurality of alternative voltages includes:

S1501: respectively inputting the multiple alternative voltages into a preset detector performance parameter prediction model to obtain the detector performance parameter corresponding to each alternative voltage.

Under a traditional test manner, about two weeks are needed for testing 2 alternative voltages, so that the test period is quite long; the test depends on various measuring instruments, so that a test device cost is high. In addition, for each test, an appointment needs to be made with a radiologist in advance, so that the test time depends on the time of the radiologist, flexibility of the test time is low, and medical resources are occupied. That is, when there are many alternative voltages, if the detector performance parameters are obtained by using the traditional actual test manner, the test period is quite long, and a test labor cost and the test device cost are high. In the method according to the embodiment of the application, the detector performance parameters under the condition that the PET detector is loaded with the alternative voltage are predicted by pre-training the detector performance parameter prediction model and utilizing a deep learning model, an AI model, or the like.

The process of predicting the detector performance parameters based on the detector performance parameter prediction model can be performed at any time, time flexibility is high, the process can be automatically executed when workers have a rest, an efficiency of acquiring the detector performance parameters can be greatly improved, the execution process does not need to depend on professional medical personnel, occupation of the medical resources is avoided, dedicated measuring instruments are not needed, and a hardware cost of a testing link is reduced.

In an embodiment, as shown in FIG. 16, a training process of the detector performance parameter prediction model includes:

S1601: acquiring a second training sample set, the second training sample set including a plurality of voltage values and detector actual performance parameters corresponding to the voltage values. The acquisition of the second training sample set may be based on historical usage records of the PET detector. The detector actual performance parameters are PET detector performance parameters such as sensitivity, the energy resolution, and the time of flight determined based on detection instruments.

S1602: inputting the voltage values in the second training sample set into a second preset learning model to obtain detector predicted performance parameters corresponding to the voltage values.

S1603: adjusting model parameters of the second preset learning model based on deviations between the detector predicted performance parameters and the detector actual performance parameters until a second ending condition is met.

The step S1602 to the step S1603 may be performed repeatedly: the voltage values in the second training sample set are input into the second preset learning model to obtain the detector predicted performance parameters corresponding to the voltage values, and the model parameters of the second preset learning model are adjusted based on the deviations of the detector predicted performance parameters and the detector actual performance parameters until the second ending condition is reached.

The second ending condition may be set according to the selected second preset learning model. For example, the second ending condition may mean that a preset maximum iterative training time number is reached, or the deviation between the detector predicted performance parameter and the detector actual performance parameter is within a preset deviation range, or samples in the second training sample set are traversed. The preset deviation range may be determined based on clinical use requirements.

S1604: taking the trained second preset learning model as the detector performance parameter prediction model.

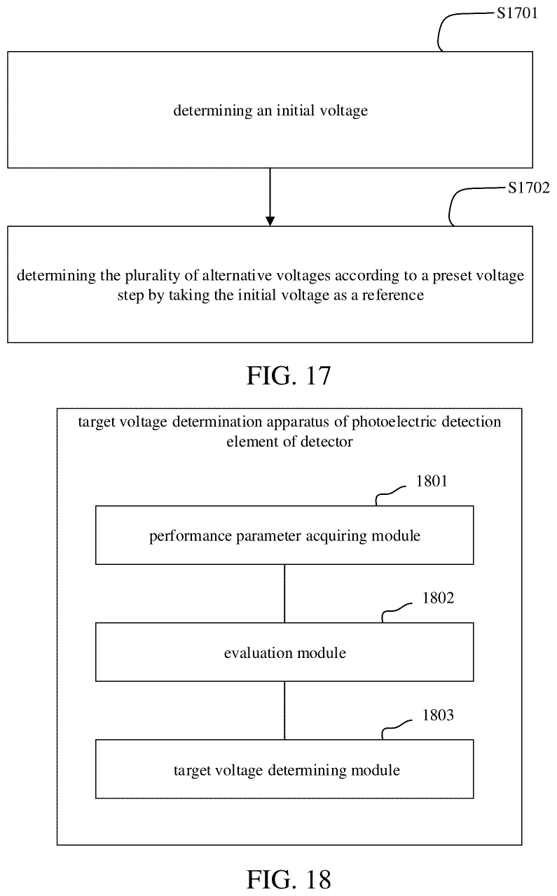

In an embodiment, as shown in FIG. 17, a step of acquiring the plurality of alternative voltages includes:

S1701: determining an initial voltage. The initial voltage is a voltage value commonly used in application scenarios of the PET detector. For example, the initial voltage may be 40V.

S1702: determining the plurality of alternative voltages according to a preset voltage step by taking the initial voltage as a reference. The preset voltage step can be set according to a precision requirement of the target voltage, and the higher the precision requirement is, the smaller the preset voltage step is. For example, in an embodiment, the preset voltage step is 0.5V.

In an embodiment, the step S1702 includes: determining the plurality of alternative voltages according to the preset voltage step within a preset voltage range by taking the initial voltage as a reference. By generating the alternative voltages under the constraint of the voltage range, the situation that the alternative voltages are generated endlessly to increase a calculated amount in the process of determining the target voltage can be avoided.

For example, the voltage range may be [38V, 42V]. In this case, with 40V as the initial voltage and 0.5V as the preset voltage step, the generated alternative voltages may be: 38V, 38.5V, 39V, 39.5V, 40V, 40.5V, 41V, 41.5V, and 42V.

In an example, the preset voltage range may also be 40V to 45V, the preset voltage step is 0.5V, the initial voltage is 40V, and by performing the above method steps, 11 alternative voltages (40V, 40.5V, 41V, 41.5V, 42V, 42.5V, 43V, 43.5V, 44V, 44.5V, and 45V) may be automatically generated, and the step of acquiring the detector performance parameters is performed under the 11 alternative voltages, so as to obtain the detector performance parameters under the 11 alternative voltages.

It should be understood that, although the steps in the flow charts involved in the above embodiments are shown in sequence as indicated by the arrows, the steps are not necessarily performed in sequence as indicated by the arrows. Unless explicitly stated herein, the steps are not limited to being performed in the exact order and may be performed in other orders. At least part of the steps in the flow charts involved in the above embodiments may include multiple steps or multiple stages, which are not necessarily performed at the same moment, but may be performed at different moments, and the steps or the stages are not necessarily performed in sequence, but may be performed alternately with other steps or at least part of the steps or the stages in other steps.

Based on the same inventive concept, the embodiment of the present application further provides a target voltage determination apparatus for a photoelectric detection element of a detector for implementing the above target voltage determination method for a photoelectric detection element of a detector. The implementation solution for solving problems provided by the apparatus is similar to the implementation solution described in the above method, and therefore, for the specific definitions in one or more embodiments of the target voltage determination apparatus for a photoelectric detection element of a detector provided below, reference can be made to the definitions of the target voltage determination method for a photoelectric detection element of a detector in the above description, and the definitions are not repeated herein.

In an exemplary embodiment, as shown in FIG. 18, there is provided a target voltage determination apparatus for a photoelectric detection element of a detector, including: a performance parameter acquiring module 1801 configured to acquire detector performance parameters corresponding to a plurality of alternative voltages; an evaluation module 1802 configured to input the detector performance parameters into a preset evaluation model to obtain an evaluation result corresponding to each alternative voltage; and a target voltage determining module 1803 configured to select the alternative voltage with the optimal evaluation result as a target voltage.

For meanings of the terms such as the detector performance parameter, reference may be made to the description of the above embodiments, and details are not repeated herein.

The modules in the target voltage determination apparatus for a photoelectric detection element of a detector may be wholly or partially implemented by software, hardware and a combination thereof. The modules may be embedded in or independent of the processor in the computer device in hardware, or may be stored in the memory in the computer device in software, such that the processor can conveniently call the modules to execute the operations corresponding to the modules. The target voltage determination apparatus for a photoelectric detection element of a detector may also include other modules or units to perform other steps of the above method embodiments and achieve the corresponding beneficial effects.

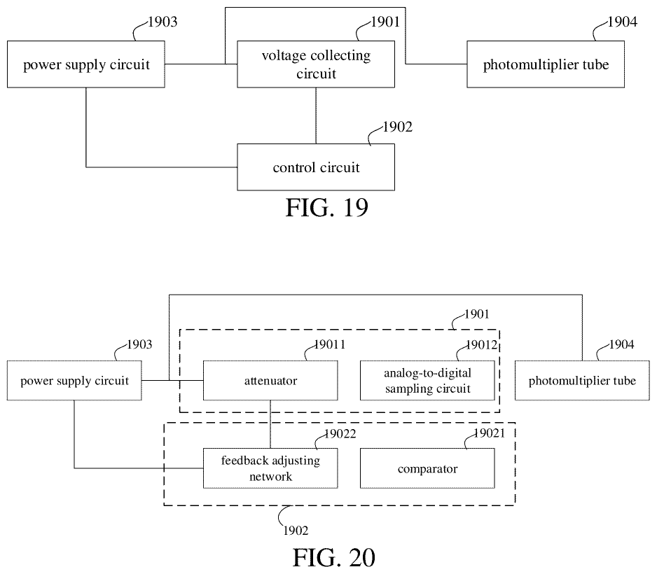

In an embodiment, as shown in FIG. 19, there is provided a supply voltage adjusting circuit for a photoelectric detection element of a detector, including a voltage collecting circuit 1901 and a control circuit 1902.

An input end of the voltage collecting circuit 1901 is configured to be connected to an output end of a power supply circuit 1903, so as to collect an actual output voltage of the power supply circuit 1903. An input end of the control circuit 1902 is connected to an output end of the voltage collecting circuit 1901, an output end of the control circuit 1902 is configured to be connected to a controlled end of the power supply circuit 1903, and the control circuit 1902 is configured to adjust the power supply circuit 1903 according to a target voltage and the actual output voltage, so as to cause the actual output voltage to be stabilized at the target voltage; the target voltage is determined by performing the steps of the above method.

The actual output voltage output from the power supply circuit 1903 to a photomultiplier tube 1904 is collected by the voltage collecting circuit 1901 and then input to the control circuit 1902, the control circuit 1902 adjusts the power supply circuit 1903 based on the target voltage and the actual output voltage to realize closed-loop control, and output of the power supply circuit 1903 can be adjusted based on real-time output of the power supply circuit 1903, so that closed-loop adaptive adjustment of the supply voltage is realized, the stable target voltage is provided for the photomultiplier tube, and an improvement of a performance of the PET detector is facilitated.

It should be understood that a plurality of photomultiplier tubes arranged in an array may be included in the PET detector, and in this case, the power supply circuit may provide the corresponding target voltages for the plurality of photomultiplier tubes in a one-to-one correspondence manner. Adjustment of the supply voltages of the individual photomultiplier tubes can be independent of one another.

In an embodiment, as shown in FIG. 20, the voltage collecting circuit 1901 includes an attenuator 19011 and an analog-to-digital sampling circuit 19012.

An input end of the attenuator is configured to be connected to the output end of the power supply circuit, and the attenuator is configured to attenuate the output voltage of the power supply circuit and output the attenuated output voltage; an input end of the analog-to-digital sampling circuit is connected to the input end of the attenuator, the analog-to-digital sampling circuit is configured to perform analog-to-digital conversion on an input signal and then amplify the result by a preset factor, and the preset factor is the same as an attenuation factor of the attenuator.

The attenuator may be a resistive attenuator, for example, the attenuator may include a plurality of serially connected voltage dividing resistors, and the voltage divided by the resistors may be smaller than the voltage at the output end of the power supply circuit, so as to implement voltage reduction to meet input signal requirements of the analog-to-digital sampling circuit. For example, if an input port of the analog-to-digital sampling circuit has a voltage range of 0 to 3.3V, the selected attenuator needs to support attenuation of the output voltage of the power supply circuit to the range of 0 to 3.3V to meet input voltage requirements of the input port.

The analog-to-digital sampling circuit converts the input voltage into a digital signal after performing analog-to-digital conversion, so that in a backward transmission process, a subsequent circuit can be a digital circuit to reduce a whole volume of the voltage collecting circuit. The analog-to-digital sampling circuit can specifically be analog-to-digital converters with different precision and digit numbers, and is specifically selected according to application scenarios. The analog-digital sampling circuit is also configured to multiply the voltage signal after analog-digital conversion by the attenuation factor to restore the voltage signal to the voltage actually output by the power supply circuit.

In an embodiment, as shown in FIG. 20, the control circuit 1902 includes a comparator 19021 and a feedback adjusting network 19022.

An input end of the comparator is connected to the output end of the voltage collecting circuit, and a reference end of the comparator is configured to receive a reference signal corresponding to the target voltage; an input end of the feedback adjusting network is connected to an output end of the comparator, an output end of the feedback adjusting network is configured to be connected to the power supply circuit, and the feedback adjusting network is configured to adjust an equivalent resistance of the power supply circuit, so as to cause the actual output voltage of the power supply circuit to be stabilized at the target voltage.

The larger the actual output voltage is, the smaller the equivalent resistance is, and conversely, the smaller the actual output voltage is, the larger the equivalent resistance is, and the actual output voltage and the equivalent resistance have a negative correlation relationship.

When the actual output voltage is inconsistent with the set target voltage, compensation for a difference is achieved through the feedback adjusting network (which may include, but is not limited to, a DAC, a digital potentiometer, an analog switch, etc.). The feedback adjusting network can monitor and control the output voltage of the power supply circuit in a closed-loop manner in real time, so as to achieve the function of self-adaptive adjustment.

For example, the feedback adjusting network may include a digital-to-analog conversion circuit and a controller, the digital-to-analog conversion circuit converts digital output of the comparator into an analog voltage signal, and then inputs the analog voltage signal to the controller, and the controller generates a control command based on output of the digital-to-analog conversion circuit (the output represents the difference between the actual output voltage and the set target voltage), and controls an on-off state of the digital potentiometer or the analog switch, so as to implement the equivalent resistance of the power supply circuit, thereby adjusting the output voltage of the power supply circuit.

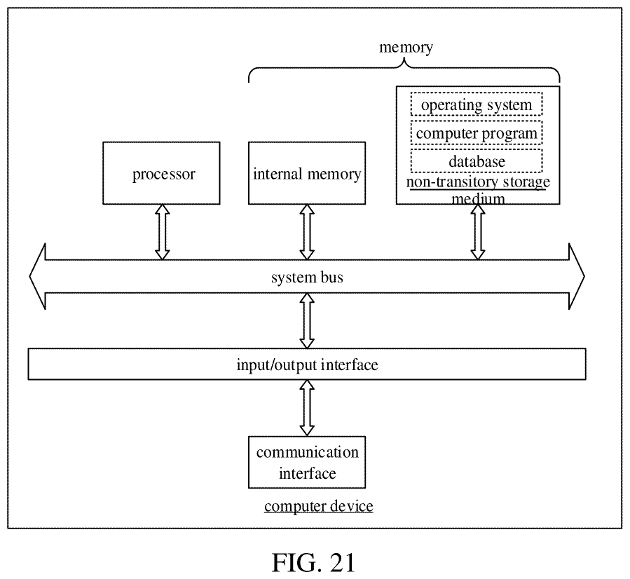

In an exemplary embodiment, there is provided a computer device, which may be a controller, an internal structure diagram of which may be shown in FIG. 21. The computer device includes a processor, a memory, an input/output (I/O) interface, and a communication interface. The processor, the memory, and the input/output interface are connected through a system bus, and the communication interface is connected to the system bus through the input/output interface. The processor of the computer device is configured to provide computing and control capabilities. The memory of the computer device includes a non-transitory storage medium and an internal memory. The non-transitory storage medium stores an operating system, a computer program, and a database. The internal memory provides an environment for operation of the operating system and the computer program in the non-transitory storage medium. The database of the computer device is configured to store angle data of a photomultiplier tube and data of an environmental magnetic field. The input/output interface of the computer device is configured to exchange information between the processor and an external device. The communication interface of the computer device is configured to be communicated with an external terminal through a network connection. The computer program, when executed by the processor, implements the supply voltage gain compensation method for a photoelectric detection element of a detector or the target voltage determination method for a photoelectric detection element of a detector according to the above embodiments.

Those skilled in the art will appreciate that the structure shown in FIG. 21 is only a block diagram of a part of the structure associated with the application solution and does not constitute a limitation on the computer device to which the application solution is applied, and a particular computer device may include more or fewer components than shown components, or combine certain components, or have a different arrangement of components.

In an exemplary embodiment, there is provided a computer device, including a memory and a processor, the memory storing a computer program, and the processor implementing the steps in the above embodiments of the supply voltage gain compensation method for a photoelectric detection element of a detector or the target voltage determination method for a photoelectric detection element of a detector when executing the computer program.

In an embodiment, there is provided a computer-readable storage medium having a computer program stored thereon, the computer program, when executed by a processor, implementing the steps of the above embodiments of the supply voltage gain compensation method for a photoelectric detection element of a detector or the target voltage determination method for a photoelectric detection element of a detector.

In an embodiment, there is provided a computer program product including a computer program, the computer program, when executed by a processor, implementing the steps of the above embodiments of the supply voltage gain compensation method for a photoelectric detection element of a detector or the target voltage determination method for a photoelectric detection element of a detector.

It should be noted that user information (including but not limited to user device information, user personal information, or the like) and data (including but not limited to data for analysis, stored data, displayed data, or the like) involved in the present application are information and data authorized by the user or sufficiently authorized by each party, and collection, use and processing of relevant data require compliance with relevant regulations.

It will be understood by those skilled in the art that all or part of the processes of the method according to the embodiments described above may be implemented by a computer program instructing related hardware, and the computer program may be stored in a non-transitory computer-readable storage medium, and when executed, may include the processes of the embodiments of the method described above. Any reference to memories, databases or other media used in the embodiments of the present application can include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The transitory memory can include a random access memory (RAM), an external cache memory, or the like. By way of illustration and not limitation, the RAM can take many forms, such as a static random access memory (SRAM), a dynamic random access memory (DRAM), or the like. The databases involved in the embodiments of the present application may include at least one of relational and non-relational databases. The non-relational database may include, but is not limited to, a block chain-based distributed database, or the like. The processors referred to in the embodiments of the present application may include, but are not limited to, general processors, central processors, graphics processors, digital signal processors, programmable logic units, data processing logic units based on quantum calculations, artificial intelligence (AI) processors, or the like.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the application.

The above-described embodiments are only several implementations of the present application, and the descriptions are relatively specific and detailed, but they should not be construed as limiting the scope of the present application. It should be understood by those of ordinary skill in the art that various modifications and improvements can be made without departing from the concept of the present application, and all fall within the protection scope of the present application. Therefore, the protection scope of the present application should be subject to the appended claims.

What is claimed is:

1. A supply voltage gain compensation method for a photoelectric detection element of a detector, wherein the detector is a detector of a SPECT system, the photoelectric detection element is a photomultiplier tube, and the method comprises:
acquiring angle data of the photomultiplier tube of the detector; the angle data being used for representing a relative angle between the photomultiplier tube and an environmental magnetic field; and
outputting a voltage compensation signal to an adjustable power supply circuit according to the angle data;
wherein the voltage compensation signal is used for instructing the adjustable power supply circuit to adjust a supply voltage output to each photomultiplier tube, so as to cause an output amplitude of the photomultiplier tube to reach an expected output amplitude.

2. The method according to claim 1, wherein outputting the voltage compensation signal to the adjustable power supply circuit according to the angle data comprises:
determining a compensation coefficient corresponding to the angle data according to the angle data and prestored gain compensation matrix data; and
outputting the voltage compensation signal to the adjustable power supply circuit according to the compensation coefficient;
wherein the gain compensation matrix data is used for representing a mapping relationship between the angle data and the compensation coefficient.

3. The method according to claim 2, wherein a step of determining the voltage compensation signal comprises:
determining the voltage compensation signal according to the compensation coefficient, a target output gain and the following gain relation:
$$code = 10 \hat{} ( a * HV - b )$$
wherein code is the target output gain, a and b are the compensation coefficients, and HV is the voltage compensation signal.

4. The method according to claim 2, further comprising:
generating and sending a warn signal under a condition that an operating time of the detector is greater than a preset time.

5. The method according to claim 2, further comprising:
acquiring data of the environmental magnetic field; and
generating and sending a warn signal under a condition that a change amplitude of the data of the environmental magnetic field exceeds a preset amplitude.

6. The method according to claim 5, further comprising:
rotating the detector under a condition that the warn signal is generated and sent;
recording the angle data and the output amplitude of the photomultiplier tube in the rotation process; and
in the case where the output amplitude of the photomultiplier tube does not reach the expected output amplitude under at least one piece of angle data, updating the prestored gain compensation matrix data.

7. A gain compensation module applied to a detector of a SPECT system, the gain compensation module comprising:
an angle sensor, configured to collect angle data of a photomultiplier tube of the detector;
the angle data being used for representing a relative angle between the photomultiplier tube and an environmental magnetic field;
an adjustable power supply circuit, configured to provide a supply voltage for each photomultiplier tube; and
a controller, connected to the angle sensor and the adjustable power supply circuit respectively, the controller being configured to perform the steps of the method according to claim 1.

8. The gain compensation module according to claim 7, wherein the controller is configured to generate and send a warn signal under a condition that an operating time of the detector is greater than a preset time; or
the gain compensation module further comprises a Hall sensor configured to collect data of the environmental magnetic field; and the controller is connected to the Hall sensor, and the controller is configured to acquire data of the environmental magnetic field and generate and send a warn signal under a condition that a change amplitude of the data of the environmental magnetic field exceeds a preset amplitude.

9. The gain compensation module according to claim 7, wherein the angle sensor is a gyroscope, and the gyroscope has a consistent pose with the photomultiplier tube.

10. A target voltage determination method for a photoelectric detection element of a detector, comprising:
acquiring detector performance parameters corresponding to a plurality of alternative voltages;
inputting the detector performance parameters into a preset evaluation model to obtain an evaluation result corresponding to each alternative voltage; the evaluation model being a model representing different weights occupied by detector performance parameters in different dimensions in a process of predicting evaluation results; and
selecting the alternative voltage with the optimal evaluation result as a target voltage as a supply voltage of the photoelectric detection element of the detector.

11. The method according to claim 10, wherein the detector performance parameters at least comprise a time of flight, an energy resolution and sensitivity, and a training process of the preset evaluation model comprises:
acquiring a first training sample set, the first training sample set comprising detector performance parameters corresponding to a plurality of voltage values and corresponding actual evaluation results;
inputting the detector performance parameters corresponding to the voltage values in the first training sample set into a first preset learning model to obtain predicted evaluation results;
adjusting weights of the detector performance parameters in the first preset learning model based on deviations between the predicted evaluation results and the actual evaluation results corresponding to the voltage values until a first ending condition is met; and
taking the trained first preset learning model as the evaluation model.

12. The method according to claim 11, wherein a weight of the time of flight is greater than a weight of the energy resolution, and the weight of the energy resolution is greater than a weight of the sensitivity.

13. The method according to claim 10, wherein acquiring the detector performance parameters corresponding to the plurality of alternative voltages comprises:
respectively inputting the multiple alternative voltages into a preset detector performance parameter prediction model to obtain the detector performance parameter corresponding to each alternative voltage.

14. The method according to claim 13, wherein a training process of the detector performance parameter prediction model comprises:
acquiring a second training sample set, the second training sample set comprising a plurality of voltage values and detector actual performance parameters corresponding to the voltage values;
inputting the voltage values in the second training sample set into a second preset learning model to obtain detector predicted performance parameters corresponding to the voltage values;
adjusting model parameters of the second preset learning model based on deviations between the detector predicted performance parameters and the detector actual performance parameters until a second ending condition is met; and
taking the trained second preset learning model as the detector performance parameter prediction model.

15. The method according to claim 10, wherein a step of acquiring the plurality of alternative voltages comprises:
determining an initial voltage; and
determining the plurality of alternative voltages according to a preset voltage step by taking the initial voltage as a reference.

16. The method according to claim 10, wherein the different weights occupied by the detector performance parameters in different dimensions in the process of predicting the evaluation results are determined based on machine learning training.

17. The method according to claim 11, wherein the first preset model comprises a normalization model and a weight-based scoring model, the normalization model is configured to normalize detector performance parameters in multiple dimensions, and then input the normalized results into the weight-based scoring model, and the scoring model is:
$$Y = \sum ( Ki * Xi )$$
wherein Y is the evaluation result, Ki is the weight of the detector performance parameter in an ith dimension, and Xi is the normalized result of the detector performance parameter in the ith dimension.

18. The method according to claim 11, wherein the first ending condition means that a preset maximum iterative training time number is reached, or the deviation between the predicted evaluation result and the actual evaluation result corresponding to the voltage value is within a preset deviation range, or training samples in the first sample training set are traversed.

19. The method according to claim 11, wherein the weight of the time of flight is greater than the weight of the energy resolution, and the weight of the energy resolution is greater than or equal to the weight of the sensitivity.

20. The method according to claim 13, wherein the second ending condition means that a preset maximum iterative training time number is reached, or the deviation between the detector predicted performance parameter and the detector actual performance parameter is within a preset deviation range, or samples in the second training sample set are traversed.
